(19) United States
(12) Patent Application Publication
(10) Pub. No.: US 2004/0015595 A1
(43) Pub. Date: Jan. 22, 2004

(54) System and method for generating synchronous playback of slides and corresponding audio/video information

(76) Inventors: Chris Lin, Taipei (TW); Aken Shiah, Shinjuang City (TW)

Correspondence Address: FISH & RICHARDSON PC, 225 FRANKLIN ST, BOSTON, MA, 02110, US

(21) Appl. No.: 10/120,021

(22) Filed: Apr. 10, 2002

(30) Foreign Application Priority Data
Apr. 11, 2001 (TW) 90108712

(51) Int. Cl. G06F 15/16

(52) U.S. Cl. 709/230

(57) ABSTRACT

A system and method for generating and playing multimedia presentations. The method synchronous records multimedia data for the presentation. The system includes a record unit, an output unit and a play unit. The record unit processes the timing between slide files and multimedia data during presentation. The output unit converts the output of the record unit to a plurality of web page files. The play unit having a browser processes the web page files to generate the multimedia presentation comprising multimedia data.

This application claims priority from Taiwanese application no. 90108712, filed with the Taiwanese Patent Office, Taiwan, on Apr. 11, 2001, pursuant to 35 U.S.C. 119(a)-(d).

### BACKGROUND OF THE INVENTION

1. Field of the Invention

The present invention relates in general to a system and method to generate slides and corresponding multimedia.

2. Description of the Related Art

Slides generated by conventional software, such as Microsoft PowerPoint, only comprise static data. The presenter must operate the software to control the procedure of playback and the effects in coordination with user's description.

A disadvantage with the conventional method is that the procedure to play the software and the content of speech may be confusing or impossible without the speaker. Moreover, if the speaker records speech in audio or video in advance, other presenters cannot combine their own audio or video with the content of the presentation.

### SUMMARY OF THE INVENTION

The object of the present invention is to provide a system and a method of recording the information to operate the presentation software, such as the playing time of each slide, and the control events to operate the presentation software, such as animation or mouse directions. Then, the presentation software file is transformed to a web page file. The web page comprises the multimedia effect recorded by the speaker in advance.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a diagram of the system according to the present invention describing the generation of the synchronous presentation of slides and accompanying multimedia data.

FIG. 2 is a diagram of the record unit of the system according to the present invention.

FIG. 3 is a diagram of the output unit of the system according to the present invention.

FIG. 4 is a diagram of the play unit of the system according to the present invention.

### DETAILED DESCRIPTION OF THE PREFERRED EMBODIMENT

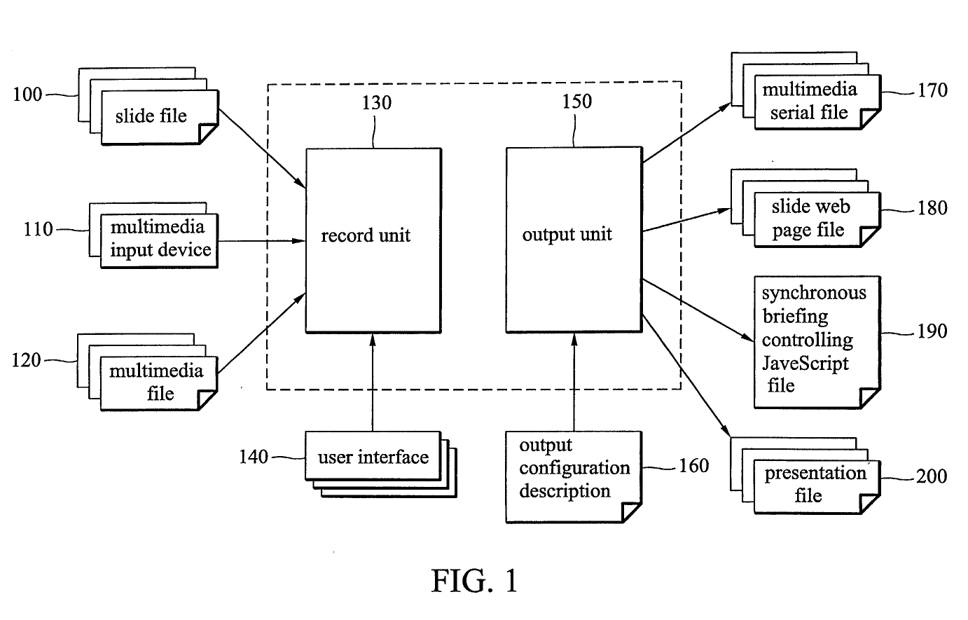

FIG. 1 shows slide file 100 to be played and corresponding multimedia file 120 comprising video and audio data. The slide file 100 and the multimedia file 120 are the input elements of the system of the present invention. This is a “file mode” of the present system. Next, serial-synchronous edit is performed according to the slide file 100 and the multimedia file 120. The other mode of the present system is “live multimedia recording mode”. In this mode, the multimedia file 120 is provided by multimedia input device 110. The record unit 130 loads the slide file 100 and displays the slide file 100 on the slide window in the upper-right region of the monitor, and loads the multimedia files 120 and displays the multimedia file 120 on the slide window in the upper-left region of the monitor. The corresponding slide file 100 and the multimedia file 120 are displayed on the monitor at the same time. Users operate the “Next” and “Last” controls of the user interface 140 to preview the slides or operate “To” to switch the slides or select a scale drawing of the slides. The “Play” function is performed to play the multimedia file 120, then the “Add Slides” control adds the present slide to the slide file 100. The simplest use pauses the playing multimedia file 120, and selects a slide to be played. After adding the slide, the label representing the required playing time of the multimedia file is marked and the number of the slide is assigned. In addition, the stamp can be dragged to the desired slide and the slide added to the slide file. The slides having different efficacy animations are coped respectively. If, for example, there are three efficacy animations in the slide, “Add Slides” must be performed three times to show all the efficacy animations. The length of the label is increased after adding a slide, and the range of each efficacy animation is displayed.

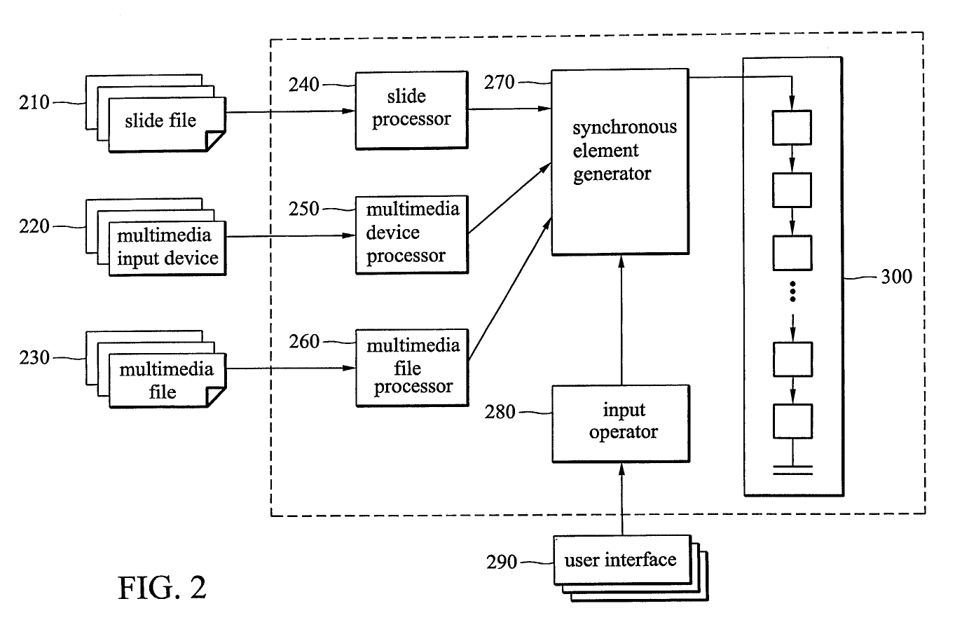

In FIG. 2, the timing realtionship between the generation of the slide file 210 and the multimedia file 230 by the operating the user interface 290 during showing the slide and the corresponding multimedia file is described. When the user operates the “Add Slides” function of the user interface 290 to add a slide, the input operator 280 generates a event 281 to a synchronous element generator 270. Then the information of the added slide is obtained by the synchronous element generator 270 from slide processor 240, for example, the number of the slide and the information of the playing slide is obtained by the synchronous element generator 270 from slide processor 240, for example, the time stamp of the slide. The synchronous element generator 270 combines the information of the playing slide and the added slide to generate a synchronous element, and then added to the synchronous element link 300. The generation of the synchronous element link 300 establishes the timing relationship between the slide file 210 and the multimedia file 230. Therefore, the multimedia output unit 350 obtains the desired synchronous information.

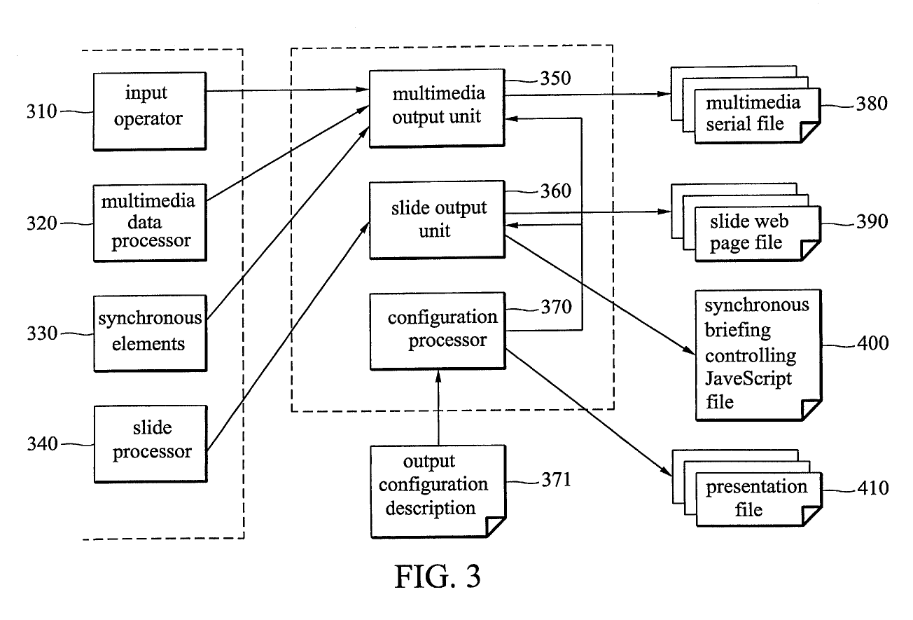

In FIG. 3, the configuration processor 370 of the multimedia output unit 350 outputs a presentation file 410 according to the output configuration description 371 selected by the user, and provides the display parameter corresponding to the presentation file 410. The display parameter comprises resolution of image, the position of the image window, the position of slides, the position of the index of the slides, and the setting of adding multimedia and the type of display. Therefore, the multimedia output unit 350 and the slide output unit 360 output files 380, 390, and 400 according to the display parameter. The multimedia output unit 350 receives multimedia data from multimedia data processor 320 and the synchronous elements 330 of the storing element, and generates the multimedia serial file 380. The data structure of the multimedia serial file 380 comprises a marker region and a script region. The marker region records the continuous time and the corresponding number of the slide of the multimedia serial file 380. The script region records the corresponding time of the number of the slide of the multimedia serial file 380. The multimedia serial file 380 is generated during the conversion of the file. The AVI files and the WAV files are suitable for use as Windows Media files to be played on the Internet, and as MPEG or MP3 files. The slide output unit 360 converts the slide file 210 to a slide web page file 390, viewable on a browser 440. At the same time, the synchronous briefing controlling JaveScript file 400 is generated by the slide output unit 360, which is a synchronous presentation-process control file. The synchronous briefing controlling JaveScript file 400 comprises scripts to process the events from the browser 440 and to feed the position of the slide back to the broswer 440. In this embodiment, languages used with the browser 440 not only include JavaScript, but also VBScript.

Therefore, the browser 440 cutouts the file having the slides and the multimedia data during the presentation.

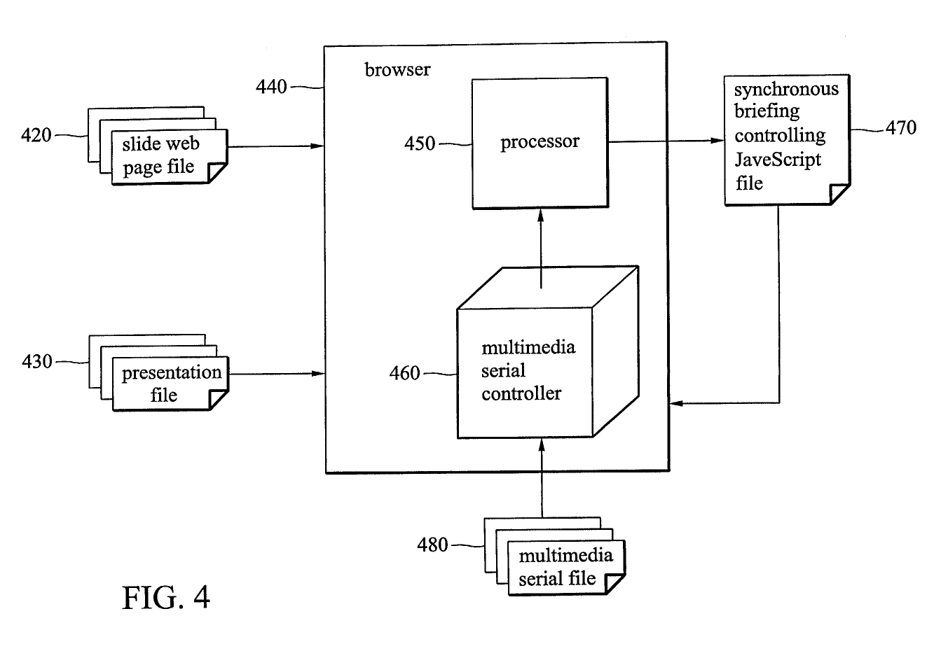

In FIG. 4, the browser 440 comprises a multimedia serial controller 460. Microsoft Internet Explorer uses Microsoft ActiveX to activate control elements within the HTML web page. The presentation file 430 is loaded first to ensure the position of the displayed window. Then the slide web page file 420 is loaded to display the displayed window of the first page of slides set in the presentation file 430. Then, the multimedia serial controller 460 starts to play the multimedia serial file 480, and generates marked events according to the marker region of the multimedia serial file 380. The event processor 450 of the browser processes the marked events to obtain the corresponding position of the slide web page file 420. Therefore, when the position of the multimedia serial file 480 to be played is changed, the corresponding slide is obtained and displayed at a predetermined window. When the user selects one of the slides in the index of the slides of the web page, the multimedia serial controller 460 performs the command of the Script region of the multimedia serial file 480, and goes to the corresponding playing position of the multimedia data according to the number of the slide.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A system to generate and play multimedia presentations, also recording multimedia information for use during the presentation, comprising:
a record unit having a user interface for processing the timing between slide files and multimedia files to generate synchronous information;
an output unit for transforming the slide files, multimedia files, and synchronous information to a plurality of web page files; and
a play unit having a browser for processing the web page files to generate the multimedia presentation comprising multimedia data.

2. The system to generate and play the multimedia presentation as claimed in claim 1, wherein the multimedia files are provided by a multimedia input device.

3. The system to generate and play the multimedia presentation as claimed in claim 1, wherein the web page files further comprise multimedia serial files, slide web page files, synchronous presentation-process control files, and briefing-type files.

4. A method to generate and play a multimedia presentation, comprising the following steps:
displaying slide files loaded by a record unit on a monitor;
displaying multimedia flies by the record unit;
generating synchronous information of the timing relationship between the slide files and the multimedia files;
converting the slide files, the multimedia flies, and the synchronous information to form web page files, made up of multimedia serial files, slide web page files, synchronous presentation-process control files, and briefing-type files, to be played by a browser;
viewing the web page files on a browser, comprising the following steps:
loading the briefing-type files;
loading the slide web page files and playing the multimedia serial files;
synchronously displaying the slide web page files according to events generated during processing of the multimedia serial files by processing the synchronous presentation-process control files; and
synchronously displaying the slide web page files according to the adjusted position of the slide web page files by processing the synchronous presentation-process control files;
